(19) United States
(12) Patent Application Publication
(10) Pub. No.: US 2014/0176301 A1
(43) Pub. Date: Jun. 26, 2014

(54) Remote Function Fob for Enabling Communication Between a Vehicle and a Device and Method for Same

(71) Applicant: Lear Corporation, Southfield, MI (US)

(72) Inventors: Jose Gabriel Fernandez Banares, Valls (ES); Riad Ghabra, Dearborn Heights, MI (US)

(73) Assignee: Lear Corporation, Southfield, MI (US)

(21) Appl. No.: 14/041,134

(22) Filed: Sep. 30, 2013

Related U.S. Application Data
(60) Provisional application No. 61/740,037, filed on Dec. 20, 2012.

(51) Int. Cl. G07C 9/00

(52) U.S. Cl. CPC G07C 9/00015
USPC 340/5.26; 340/5.61

(57) ABSTRACT

A remote function fob associated with a vehicle is disclosed, the fob for enabling secure communication between the vehicle and a device. The fob may include a transceiver configured for communication with the device. The fob may further include a controller which may be configured to enable secure communication with the device via the transceiver. The controller may be further configured for operation with a code generated using a security protocol, the code to be used in secure communication between the device and the vehicle, the code for transmission to the device via the transceiver.

### CROSS-REFERENCE TO RELATED APPLICATIONS

The present application claims the benefit of U.S. Provisional Patent Application No. 61/740,037 filed on Dec. 20, 2012, the disclosure of which is incorporated in its entirety by reference herein.

### TECHNICAL FIELD

The following relates to a fob and a method for managing secure access to vehicle functions, data and/or systems by remote devices and/or by a user at a remote location.

### BACKGROUND

In the near future, a vehicle user may wish, while being far away from the car (e.g., in the office, at home, in the supermarket, etc.) to do one or more of the following:
On a hot day, open the car windows a little or activate the HVAC;
In the event of rain, close car windows left open;
In preparation for a trip, upload the itinerary into the car navigation system and upload a new set of songs and/or videos into the car infotainment system;
After a trip, download car statistics from the trip to a personal computer (PC) for review and to check car status data;
After a prompt from a vehicle system regarding an anomaly, download files with a report of the anomaly to send to a service center.

All these activities require remote access to the car electronic data, but the car must recognize the user beyond doubt before allowing the user access. A security password for these cases should be very complicated in order to ensure no undesired access, and would require more than what can be remembered by the user. It would be better to have a device to ensure this type of permission.

Systems known today for providing secure access include a security access number provided with the car in a card. This has to be “handled” by the user and thus it has to be simple enough to be read and typed by said user. Not complex passwords can be considered and the system security is low.

Another known system is a fingerprint access system. This is a high security access system, but must be incorporated into the car so that fingerprint data may be compared with an authorized database when sent through the internet or other remote access system. This system is also needed at the location where the user is attempting to remotely access the vehicle.

A dedicated tool, such as those used at service centers, could also be employed to provide secure access. However, this would require a user to purchase and use such a dedicated device, and also would not be available everywhere.

A Personal Identity Card (PIC) could also be used for secure access. This could be taken anywhere by a user as it could be used for other purposes. However, as with fingerprint access, the car also must be equipped with a card reading system, which would also be required at the location from which the user attempts remote access. As well, both fingerprint systems and PIC systems would be subject to standardization not controlled by the vehicle manufacturer. As a result, a vehicle manufacturer might select a system that could become obsolete after a period of time.

As a result, the need exists for a key fob and method using such a fob for secure access to the vehicle from a remote location to enable such actions as described above using the vehicle fob. A security access system based in the fob minimizes cost, provides greater flexibility (e.g., extra size, place where available, and time duration), and minimizes extra components while enabling full control by the vehicle manufacturer. A remote car data and command access system by means of security access codes managed by the car fob permits the car fob to function as the security access key to enable a personal computer (PC), mobile smart phone, personal digital assistant (PDA), or other devices to communicate with the car to share data, commands, etc.

### SUMMARY

According to one embodiment disclosed herein, a remote function fob associated with a vehicle is provided, the fob for enabling secure communication between the vehicle and a device. The fob comprises a transceiver configured for communication with the device, and a controller configured to enable secure communication with the device via the transceiver. The controller is further configured for operation with a code generated using a security protocol, the code to be used in secure communication between the device and the vehicle, the code for transmission to the device via the transceiver.

According to another embodiment disclosed herein, a method is provided for enabling secure communication between a vehicle and a device using a remote function fob associated with the vehicle. The method comprises receiving at the fob a secure communication from the device, the communication from the device comprising a request for a code to be used in secure communication between the device and the vehicle. The method also comprises generating a code using a security protocol, the code to be used in secure communication between the device and the vehicle. The method further comprises transmitting a secure communication from the fob to the device, the communication from the fob comprising the code to be used in secure communication between the device and the vehicle.

A detailed description of these and other embodiments of a key fob and method for managing secure access to a vehicle from a remote location by a device and/or a user is set forth below together with accompanying drawings.

### BRIEF DESCRIPTION OF THE DRAWINGS

FIG. 1 is a simplified flowchart of an exemplary synchronization method between a vehicle and a key fob;

FIG. 2 is a simplified flowchart of an embodiment of a method using a key fob for managing secure access to a vehicle from a remote location by a device;

FIG. 3 is a simplified block diagram of an embodiment of a key fob for managing secure access to a vehicle from a remote location by a device;

FIG. 4 is a simplified block diagram of another embodiment of a key fob for managing secure access to a vehicle from a remote location by a device;

FIG. 5 is a simplified block diagram of another embodiment of a key fob for managing secure access to a vehicle from a remote location by a device; and

FIG. 6 is a simplified block diagram of another embodiment of a key fob for managing secure access to a vehicle from a remote location by a device.

### DETAILED DESCRIPTION

As required, detailed embodiments are disclosed herein. However, it is to be understood that the disclosed embodiments are merely exemplary and may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

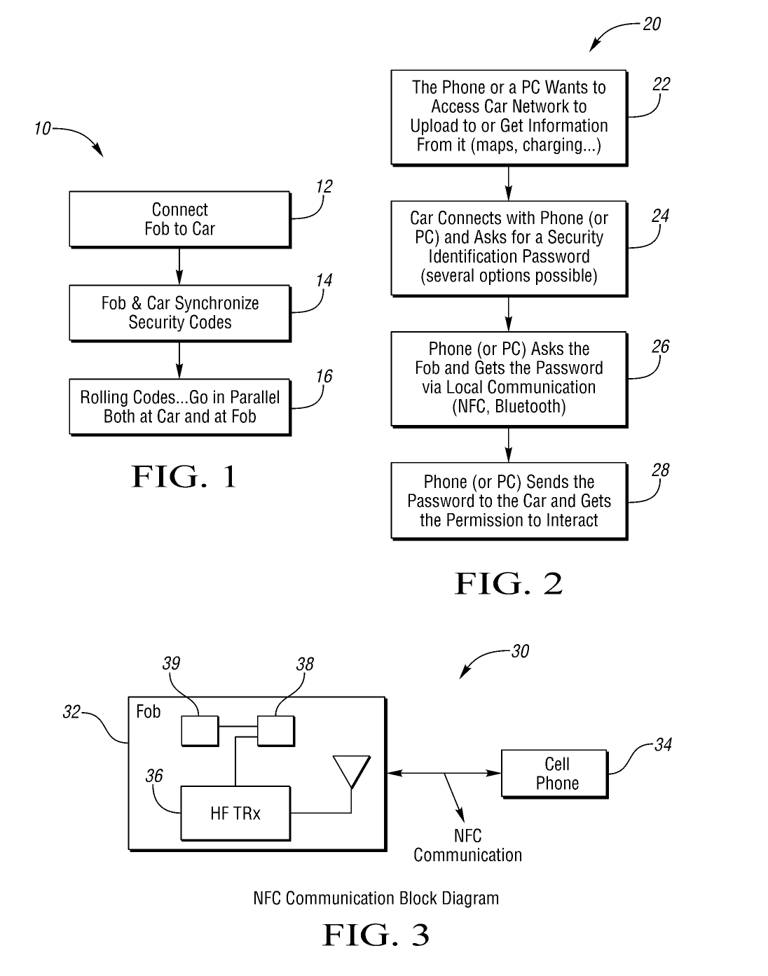

With reference to FIGS. 1-6, a more detailed description of embodiments of a vehicle remote function fob and method using such a fob for managing secure access to a vehicle from a remote location by a device and/or a user will be provided. In the present vehicle market, the final user is demanding vehicles with infotainment. In the near future, the final user will also want to remotely ask the car to pre-heat, to change charging status, to download a map, etc. However, the car “needs” a sure means to recognize the user because such request will come through Internet (e.g., from user's mobile smart phone or PC). Thus a security code encryption system is required.

In the market, however, there are many different types of smart phones and PCs. Such devices also evolve every year, while a car may last 5 to 15 years. Thus it is very challenging to ensure an encryption system that may be as stable as the car. Available access systems require a user to remember a password, or to have a fingerprint access system (which must also be authorized by the vehicle manufacturer). Remembering a password is complicated and enables the use of only simple codes, thereby lowering security. Fingerprint access systems are just becoming available and require fingerprint learning by the car and a system to share such data. It may also be not only the responsibility of the vehicle manufacturer to provide such a system, as it would also be required for use at a remote location. A vehicle fingerprint system for this purpose would also add significant cost to a vehicle (e.g., fingerprint reader, processing circuitry, algorithm, etc.).

In contrast, the key fob is with the user when the user needs to remotely access the car. Moreover, the key fob has been designed by the vehicle manufacturer, thereby matching the vehicle systems, and will last as long as the vehicle. It is reasonable then, to have the key fob be the security code provider. The key fob is directly connected to the car frequently, so that the code may be synchronized as many times as needed. They security code system may be isolated from the rest of electronics. The key fob may provide the access code to the PC or the mobile smart phone through USB, Bluetooth or WiFi, with the electronics required for this being minimal. If a USB connection is used, that connection may also be used to recharge the key fob battery. A key fob based system and method would also offer the vehicle manufacturer a security access system that would not require compatibility with a plethora of external devices that are increasing each year.

The vehicle key fob is a device that is available to a vehicle user at any moment and is “matched” with the car (as it is from the car manufacturer). To provide user authentication and manage secure access to the vehicle by remote devices and/or by a user at a remote location, the fob may comprise appropriate hardware and/or software for communication with a PC, mobile smart phone, PDA or the like. Such communication may be provided via a small USB port, Bluetooth, Wi-Fi, Radio Frequency (RF) or other appropriate systems.

Such a fob may also include the capability to generate security codes, to share them with the car and to change them periodically. Key Fobs already do this (or equivalent) for nearby remote car opening. The same or an equivalent protocol may be used. While in direct connection or communication with the car (either in the car key-hole or through short-range RF) the security codes may be changed and shared between the car and the fob.

Such a system may also comprise Internet or equivalent capabilities in the car for remote access to share data (with high security access system). Such a system may also comprise appropriate software programs in a PC, mobile phone, PDA or the like to manage access to the car (e.g., receive the access code from the fob, communicate with the car, sending the fob code, etc.), and then to share the required data or commands (e.g., move windows, user preferences, HVAC, infotainment data, vehicle software upgrades, etc.).

When the car and a matched fob are sold by the vehicle manufacturer, the manufacturer may retain responsibility over ensuring access security (e.g., what can be remotely accessed and how) and to enable this external communication. The indicated software could also be sold with the car.

Such a system and method may be provided for any car with a key fob where remote synchronization is desired, thereby providing a vehicle manufacturer with a means for the car to safely recognize a user in order to prevent undesired remote accesses to the vehicle. Such a system and method may be provided for use with remote infotainment systems widely provided by vehicle manufacturers, and would not require a user to remember long secure codes or to have them written elsewhere. Such a system and method would also provide a cost savings compared to an enormous table of device characteristics stored in the car for compatibility purposes and yearly upgrades of such a table (e.g., user time, servicing by vehicle manufacturers, etc.), and may be implemented with minimal electronics and associated costs. In the event a standardized encryption system is defined, software customization may also be reduced or eliminated.

Examples of use of such a system include a user in an office who receives an e-mail indicating that the user must leave the office three hours earlier than expected. In that event, the user may contact the car through mobile smart phone to change the charging speed from an economy mode to a fast-charging mode. The mobile phone may contact the key fob through Bluetooth (no user action required) to get a valid vehicle access code and send the necessary commands to the car. The car acknowledges the user and changes the vehicle charging status. When the time arrives the user can leave the office with the car fully charged again.

According to another example, a home user may have a trip scheduled for the following day. The user has found the proper route in Google Maps. The user contacts the car through the internet to upload this programmed route in the vehicle navigation system. A PC contacts the key fob through Bluetooth (no user action required) to get a valid vehicle access code and sends the respective data files. The car uploads this data and is prepared to guide the user on the trip the next day. If a USB connection is used, the key fob battery may also be charged, thereby extending the key fob life.

In still another example, a vehicle manufacturer that has discovered a software bug in a vehicle Electronic Control Unit (ECU) may send an e-mail to vehicle users/owners to access the vehicle manufacturer's website to request a vehicle software upgrade. The car recognizes the vehicle manufacturer's website as valid, accesses the appropriate data and asks the user for permission download the data to upgrade the vehicle software. The user PC then gets permission from the key fob and sends it to the car. The software upgrade then takes place without the user having to go to a service center, thereby minimizing costs to the vehicle owner/user and manufacturer.

Thus, according to the system and method disclosed, a mobile smart phone, PC or other device (in wireless or wired communication with a car) requests access to a car. This PC or phone requests such access directly (no intermediate device), and gets a password request from the car. The PC or phone then contacts the key fob for a password, receives such a password from the fob and sends that password back to the car network. Secure access to the car by the PC or phone is then permitted on the communication already established.

With reference now to FIG. 1, a simplified flowchart is shown depicting an exemplary synchronization method 10 between a car and a key fob. As seen therein, whenever the fob is in the car, the fob connects 12 to the car and is communicating with it for standard purposes. Then, as part of this communication, security passwords may be synchronized. That is, the fob and car synchronize security codes 14. This is done so that the fob will be able to provide a security identification code in a near future. In one embodiment, rolling codes may go in parallel both at the car and at the fob 16.

Referring next to FIG. 2, a simplified flowchart is shown of an embodiment of a method 20 using a key fob for managing secure access to a vehicle from a remote location by a device and/or a user. As seen therein, a phone or a PC wants to access 22 a car network to upload to or get information from it (e.g., maps, charging, etc.). Whenever the user wants to remotely interchange data with the car, the car will require a password from the user before enabling any data transfer. In order to do so, the car may connect with the phone or PC and ask for a security identification password 24, according to any of number of possible options. The user may then take the opportunity of a device already synchronized with the car to get a password (locally). In one embodiment, the phone or PC may ask the fob and gets the password via local communication 26 (e.g, via NFC, Bluetooth or other form of communication). In such a fashion, no matter which device is used for communication with the car network, that devices will be provided with a correct password for secure access. The phone or PC then sends the password to the car and gets the permission to interact 28 without any dependency on the brand, type or other characteristics of the PC or phone.

As previously noted, such a method and system for secure access by a remote device provide the advantage that the car and fob are made and/or supplied by the same manufacturer and are thus closely related. In contrast, mobile smart phones, PCs and the like change annually, if not more often (e.g., operating system software upgrades). Moreover, it is difficult and expensive to update car software to adapt to all different types of PCs, phones and other devices that exist in the market at any time, or that may exist during the life of the car. The method and system disclosed herein enable and ensure a secure, reliable and long lasting means of remote device identification and access.

Referring now to FIG. 3, a simplified block diagram is shown of an embodiment of a system 30 using a key fob for managing secure access to a vehicle from a remote location by a device and/or a user. In particular, the system 30 relates to authorizing a cell phone 34 for vehicle access. As seen therein, the fob 32 includes a High Frequency (HF) transceiver 36 configured for Near Field Communication (NFC) with a cell phone 34.

In that regard, NFC is being rolled out today in cell phones and fobs for the purpose of electronic payment and for allowing the fob to communicate with other devices (e.g., payment terminals, cell phones, etc.). Given that the cell phone is typically replaced more frequently than the car, if cell phones are to be allowed to control vehicle functions, there needs to be a convenient method for the user to cancel authorization from his/her old phone and to authorize a new phone.

The present disclosure provides embodiments of methods and systems for managing the authorization of a cell phone for the purpose of vehicle access which may include locking/unlocking, controlling windows and moon roof, trunk access, engine starting and/or other vehicle functions. Other applications may include locating the vehicle and showing that location on a map on the phone display.

NFC communication is a batteryless method of close proximity communication. According to one method to allow access, when the phone is placed in close proximity of the fob, the fob (via the phone) can request the user to enter a special code assigned to the user at the dealer (at time of purchase). This code can be made changeable by the user through the phone interface. Once a particular cellphone is authorized it is not necessary for it to be re-authorized for each subsequent use. The NFC communication can be made encrypted and secure to disallow any kind of eavesdropping. The security is enhanced by the fact that NFC, an existing protocol as described above, relies on very close proximity which makes eavesdropping very difficult.

With the advent of low current Bluetooth solutions, it is now also feasible to add this feature to the fob. Bluetooth also enables fob to cellphone communication, which communication can be used to facilitate vehicle access. The cellphone authorization to access vehicle information can be given via the password or code entry as described above.

Alternatively, other ways of authorizing the cellphone are possible, such as using some form of biometric feature stored in the fob to be verified via the cellphone interface. This verification can also occur on the NFC channel or on Bluetooth. An example of a biometric feature would be a fingerprint.

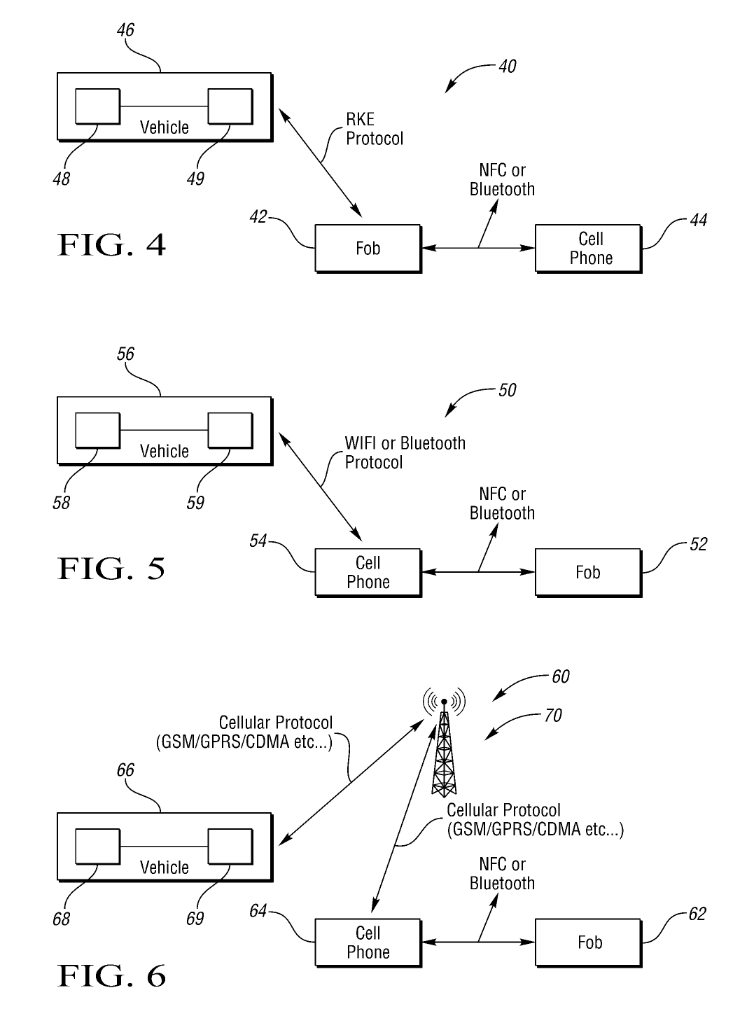

Referring next to FIGS. 4-6, simplified block diagrams are shown of alternative embodiments of a system 40, 50, 60 using a key fob for managing secure access to a vehicle from a remote location by a device, such as a cellphone. In that regard, FIG. 4 depicts a system 40 in which a fob 42 is configured to serve as an interface for communications between a cellphone 44 and a vehicle 46. Communication of the types previously described between the fob 42 and the cellphone 44 may be accomplished using an NFC or Bluetooth protocol as previously described. Communication between the fob 42 and the vehicle 46 may be accomplished using any known Remote Keyless Access (RKE) protocol.

FIG. 5 illustrates a system 50 configured to provide direct communication between a cellphone 54 and a vehicle 56. The system 50 is further configured for direct communication as previously described between the cellphone 54 and a fob 52. Here again, communication between the fob 52 and the cellphone 54 may be accomplished using an NFC or Bluetooth protocol as previously described. Communication between the cellphone 54 and the vehicle 56 may be accomplished using a WiFi or Bluetooth protocol.

FIG. 6 illustrates a system 60 configured to provide communication between a cellphone 64 and a vehicle 66 over a network such as cellular network 70. Such communication over the network 70 may be accomplished according to any know protocols (e.g., GSM/GPRS/CDMA, etc.). The system 60 is further configured for direct communication as previously described between the cellphone 64 and a fob 62. Here again, communication between the fob 62 and the cellphone 64 may be accomplished using an NFC or Bluetooth protocol as previously described.

The type of encryption used between the fob and the cellphone can be AES128, XTEA, or other type of encryption. The encryption keys used in this communication can be specific to this type and purpose and can be shared on both sides: fob and phone. The sharing of those secret keys (which do not have to be used in the communication between the fob and vehicle) can be done at the time of authorizing the cellphone as discussed above. In other words there can be a special secret key only for communication between fob and phone.

Thus, with reference to FIGS. 3-6, a remote function fob 32, 42, 52, 62 associated with a vehicle 46, 56, 66 for enabling secure communication between the vehicle 46, 56, 66 and a device 34, 44, 54, 64 may comprise a transceiver 36 configured for communication with the device 34, 44, 54, 64, and a controller 38 configured to enable secure communication with the device 34, 44, 54, 64 via the transceiver 36. The controller 38 may be further configured for operation with a code generated using a security protocol, the code to be used in secure communication between the device 34, 44, 54, 64 and the vehicle 46, 56, 66, the code for transmission to the device 34, 44, 54, 64 via the transceiver 36.

In that regard, the fob controller 38, which may also be referred to as a control unit or electronic control unit (ECU), may comprise a microprocessor, microcontroller, programmable digital signal processor (DSP) or other programmable device, as well as local storage or memory. The fob controller 38 may alternatively comprise a basic state machine with minimal processing capabilities, an application specific integrated circuit (ASIC), a programmable gate array or programmable array logic, or a programmable logic device. Where the controller 38 includes a programmable device such as a microprocessor, microcontroller or programmable DSP, the controller 38 may further include appropriate computer executable code associated with the various operations described herein, which may include a security protocol for generating a code to be used in secure communications between the device 34, 44, 54, 64 and the vehicle 46, 56, 66.

As previously described, the transceiver 36 may comprise a high-frequency transceiver configured for near field communication with the device 34, 44, 54, 64. The transceiver 36 may alternatively be configured to enable communication with the device 34, 44, 54, 64 using Bluetooth protocol. The fob 32, 42, 52, 62 and/or the fob transceiver 36 may also be configured for communication with the device 34, 44, 54, 64 via a wired connection (not shown) to the device, such as a Universal Serial Bus (USB) connection or any other type of connection. That is, the fob transceiver 36 may be configured for wireless or wired communication with the device 34, 44, 54, 64.

The fob 32, 42, 52, 62 may be part of a system, where the system comprises a control unit 48, 58, 68 adapted to be mounted in the vehicle 46, 56, 66. Here again, the vehicle mounted control unit 48, 58, 68, which may also be referred to as a control unit, electronic control unit (ECU), or Body Control Module (BCM), may comprise a microprocessor, microcontroller, programmable digital signal processor (DSP) or other programmable device, as well as local storage or memory. The vehicle control unit 48, 58, 68 may alternatively comprise a basic state machine with minimal processing capabilities, an application specific integrated circuit (ASIC), a programmable gate array or programmable array logic, or a programmable logic device. Where the control unit 48, 58, 68 includes a programmable device such as a microprocessor, microcontroller or programmable DSP, the control unit 48, 58, 68 may further include appropriate computer executable code associated with the various operations described herein, which may include a security protocol for generating a code to be used in secure communications between the device 34, 44, 54, 64 and the vehicle 46, 56, 66.

In that regard, the control unit 48, 58, 68 may be configured to use the security protocol to generate the code to be used in secure communication between the device 34, 44, 54, 64 and the vehicle 46, 56, 66. In such an embodiment, the code may be wirelessly transmitted by the vehicle control unit 48, 58, 68 to the fob 32, 42, 52, 62 using a vehicle transceiver 49, 59, 69 and fob transceiver 39 adapted for RKE communications between the vehicle 46, 56, 66 and the fob 32, 42, 52, 62, which may include use of the RKE protocol or another communication protocol. Alternatively, the code may be wirelessly transmitted by the vehicle control unit 48, 58, 68 via a vehicle transceiver (not shown) to the fob transceiver 36 and the fob 32, 42, 52, 62 using an appropriate communication protocol. Thereafter, the fob 32, 42, 52, 62 may transmit the code to the device 34, 44, 54, 64 via the fob transceiver 36.

As previously described, the code to be used in secure communication between the device 34, 44, 54, 64 and the vehicle 46, 56, 66 may be generated using any type of security protocol or algorithm, and may be encrypted using any known technique. In the above described embodiment, where the vehicle control unit 48, 58, 68 is configured to generate the code using the security protocol, the fob 32, 42, 52, 62 may store the code received from the vehicle control unit 48, 58, 68. In one embodiment, the code, which may be a rolling code, may be updated or changed at the vehicle control unit 48, 58, 68. In such an embodiment, the code stored at the fob 32, 42, 52, 62 may be updated or changed each time the fob 32, 42, 52, 62 is connected to the vehicle 46, 56, 66, such as via periodic transmissions from the vehicle control unit 48, 58, 68 when the fob 32, 42, 52, 62 is brought within range or proximate the vehicle 46, 56, 66.

Alternatively, the fob controller 38 may be configured to use the security protocol to generate the code to be used in secure communication between the device 34, 44, 54, 64 and the vehicle 46, 56, 66. Here again, code may be generated using any type of security protocol or algorithm, and may be encrypted using any known technique. The code, which again may be a rolling code, may be updated or changed in parallel at both the fob 32, 42, 52, 62 and the vehicle control unit 48, 58, 68, or each time the fob 32, 42, 52, 62 is connected to the vehicle 46, 56, 66, such as via periodic transmissions from the vehicle control unit 48, 58, 68 when the fob 32, 42, 52, 62 is brought within range or proximate the vehicle 46, 56, 66. Here again, the fob 32, 42, 52, 62 may transmit the code to the device 34, 44, 54, 64 via the fob transceiver 36.

It should also be noted that the security protocol or algorithm used for generating the code to be used in secure communication between the device 34, 44, 54, 64 and the vehicle 46, 56, 66 (whether generated by the vehicle control unit 48, 58, 68 or the fob controller 38) may also be used by the fob 32, 42, 52, 62 and the vehicle 46, 56, 66 for RKE communications. That is, the security protocol or algorithm used for generating the code to be used in secure communications between the device 34, 44, 54, 64 and the vehicle 46, 56, 66 may be different from or the same as the security protocol or algorithm used for generating a code to be used in secure communication between the fob 32, 42, 52, 62 and the vehicle 46, 56, 66.

The fob controller 38 may also be configured to act or serve as an interface for secure communications between the device 34, 44, 54, 64 and the vehicle 46, 56, 66. In that regard, as previously described, the device 34, 44, 54, 64 may comprises a cellular or mobile telephone, a personal digital assistant, a personal computer, or other device. The device 34, 44, 54, 64 and the vehicle 46, 56, 66 may be configured to communicate using any known communication protocol, such as WiFi, Bluetooth, Dedicated Short Range Communication (DSRC), a cellular communication protocol, or any other protocol.

With reference to FIGS. 2-6, a method for enabling secure communication between a vehicle 46, 56, 66 and a device 34, 44, 54, 64 using a remote function fob 32, 42, 52, 62 associated with the vehicle 46, 56, 66 may comprise receiving at the fob 32, 42, 52, 62 a secure communication from the device 34, 44, 54, 64, the communication from the device 34, 44, 54, 64 comprising a request for a code to be used in secure communication between the device 34, 44, 54, 64 and the vehicle 46, 56, 66. The method may further comprise generating a code using a security protocol, the code to be used in secure communication between the device 34, 44, 54, 64 and the vehicle 46, 56, 66.

In that regard, as previously described, the code to be used in secure communication between device 34, 44, 54, 64 and the vehicle 46, 56, 66 may be generated either by the vehicle control unit 48, 58, 68, or by the fob 32, 42, 52, 62 or the fob controller 38. The method may still further comprise transmitting a secure communication from the fob 32, 42, 52, 62 to the device 34, 44, 54, 64, where the communication from the fob 32, 42, 52, 62 comprises the code to be used in secure communication between the device 34, 44, 54, 64 and the vehicle 46, 56, 66.

As is readily apparent from the foregoing, embodiments of a remote function key fob and a method using such as for managing secure access to a vehicle from a remote location by a device and/or a user have been described. According to the embodiments described herein, a mobile smart phone, PC or other device (in wireless or wired communication with a car) may request access to a car, and receives a password request from the car. The PC or phone may then contact the key fob for a password, receive such a password from the fob and send that password back to the car network, thereby permitting and enabling secure access to the car by the PC or phone.

While various embodiments of a remote function key fob and a method using such a fob for managing secure access to a vehicle from a remote location by a device and/or a user have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the claims herein.

What is claimed is:

1. A remote function fob associated with a vehicle for enabling secure communication between the vehicle and a device, the fob comprising:
a transceiver configured for communication with the device; and
a controller configured to enable secure communication with the device via the transceiver;
wherein the controller is further configured for operation with a code generated using a security protocol, the code to be used in secure communication between the device and the vehicle, the code for transmission to the device via the transceiver.

2. The remote function fob of claim 1 wherein the transceiver comprises a high-frequency transceiver configured for near field communication with the device.

3. The remote function fob of claim 1 wherein the transceiver is configured to enable communication with the device using Bluetooth protocol.

4. The remote function fob of claim 1 wherein the transceiver is configured for communication with the device via a wired connection to the device.

5. The remote function fob of claim 1 wherein the fob is part of a system, the system further comprising a control unit adapted to be mounted in the vehicle, the control unit configured to generate the code using the security protocol.

6. The remote function fob of claim 1 wherein the controller is configured to generate the code using the security protocol.

7. The remote function fob of claim 1 wherein the device comprises a mobile telephone, a personal digital assistant, or a personal computer.

8. The remote function fob of claim 1 wherein the controller is configured to act as an interface for secure communication between the device and the vehicle.

9. The remote function fob of claim 1 wherein the device and the vehicle are configured to communicate using a communication protocol comprising WiFi, Bluetooth, or Dedicated Short Range Communication (DSRC).

10. The remote function fob of claim 1 wherein the device and the vehicle are configured to communicate using a cellular communication protocol.

11. The remote function fob of claim 1 wherein the code to be used in secure communication between the device and the vehicle comprises a rolling code.

12. The remote function fob of claim 1 wherein the security protocol is for generating a code to be used in secure communication between the fob and the vehicle.

13. A method for enabling secure communication between a vehicle and a device using a remote function fob associated with the vehicle, the method comprising:
receiving at the fob a secure communication from the device, the communication from the device comprising a request for a code to be used in secure communication between the device and the vehicle;
generating a code using a security protocol, the code to be used in secure communication between the device and the vehicle; and
transmitting a secure communication from the fob to the device, the communication from the fob comprising the code to be used in secure communication between the device and the vehicle.

14. The method of claim 13 wherein the fob comprises a high-frequency transceiver configured for near field communication between the fob and the device.

15. The method of claim 13 wherein the fob is configured for communication with the device via a wired connection to the device.

16. The method of claim 13 wherein a control unit adapted to be mounted in the vehicle is configured for generating the code using the security protocol.

17. The method of claim 13 wherein the fob is configured for generating the code using the security protocol.

18. The method of claim 13 wherein the fob is configured to act as an interface for secure communication between the device and the vehicle.

19. The method of claim 13 wherein the code to be used in secure communication between the device and the vehicle comprises a rolling code.

20. The method of claim 13 wherein the security protocol is for generating a code to be used in secure communication between the fob and the vehicle.
